(19) United States
(12) Patent Application Publication
(10) Pub. No.: US 2026/0265562 A1
(43) Pub. Date: Sep. 10, 2026

(54) QUANTUM DOT DISPERSION, QUANTUM DOT INK COMPOSITION, CURED FILM, COLOR FILTER AND DISPLAY DEVICE COMPRISING THE SAME

(71) Applicant: HANSOL CHEMICAL CO., LTD., Seoul (KR)

(72) Inventors: Hyo Jin JEON, Wanju-gun (KR); Yun Ju BAE, Wanju-gun (KR); Jun Young KIM, Wanju-gun (KR); Hyeong Bin KIM, Wanju-gun (KR); Gil Ran KIM, Wanju-gun (KR); Kyung Nam KIM, Wanju-gun (KR)

(21) Appl. No.: 19/556,289

(22) Filed: Mar. 4, 2026

(30) Foreign Application Priority Data
Mar. 10, 2025 (KR) 10-2025-0030414

(51) Int. Cl. C09D 11/50; B82Y 20/00; B82Y 40/00; C09D 11/037; C09D 11/101; C09K 11/02; C09K 11/08; C09K 11/88

(52) U.S. Cl. CPC C09D 11/50; C09D 11/037; C09D 11/101; C09K 11/025; C09K 11/0883; C09K 11/883; B82Y 20/00; B82Y 40/00

(57) ABSTRACT

A quantum dot dispersion, a quantum dot ink composition, a cured film, a color filter, and a display device comprising the same are disclosed. By incorporating quantum dots into a ligand layer containing a compound represented by Formula 1, which has an aromatic hydrocarbon group at one end and a thiol group at the other end, the quantum dot ink composition can achieve excellent refractivity, thermal stability, and photostability, and can exhibit a low viscosity suitable for excellent inkjet processability to provide high-quality displays with further improved optical properties.

### CROSS-REFERENCE TO RELATED APPLICATION

This patent document claims the benefit of Korean Patent Application No. 10-2025-0030414, filed on Mar. 10, 2025, the entire disclosure of which is incorporated by reference for all purposes as if fully set forth herein.

### TECHNICAL FIELD

The present invention relates to a quantum dot dispersion, a quantum dot ink composition, a cured film, a color filter, and a display device including the same.

### BACKGROUND

Quantum dots (QDs), also known as semiconductor nanocrystals, can emit various colors through generation of light with different wavelengths depending on particle size and have advantages of better color purity and photostability than typical light emitting materials, thereby attracting attention as next generation light emitting elements.

In particular, as a new trend in the field of displays, quantum dots may be applied to various displays, electronic devices and the like as well as TVs and LEDs. Quantum dots represented by CdSe, InP, and the like have achieved rapid improvement in quantum yield and various methods for synthesis of quantum dots with quantum yield close to 100% have been introduced in the art. As a result, TVs including quantum dot sheets have been commercialized in the art. As a next step, quantum dot TVs are being developed in which quantum dots (excluding pigments and dyes) are integrated into the color filter layer of a typical LED TV to act as self-emissive elements rather than filters. A critical challenge in development of such quantum dot TVs is maintaining the luminous efficiency of the quantum dots throughout a pixel patterning process and a manufacturing process.

In recent years, to address sophistication of materials used in quantum dot pixels and cost increases resulting therefrom, there has been a growing interest in minimizing the use of a material by applying the material only to a target area rather than patterning with typical spin coating or slit coating. For example, an inkjet method enables application of materials only to target pixels, thereby preventing unnecessary waste of the materials.

On the other hand, since photoconversion devices used in displays require a high level of long-term reliability, ligand substitution is employed to protect the core of the quantum dot from external factors, such as heat, moisture, or light, while improving quantum yield.

Korean Patent Laid-open Publication No. 10-2018-0002716 discloses a quantum dot-containing composition that includes a ligand compound having a specific structure to suppress heat-induced luminance degradation. However, to achieve low viscosity, this composition contains organic solvents, which cause thickness deviation after curing, limitations in increasing film thickness, and poor photostability, when applied to inkjet printing.

### SUMMARY

It is one aspect of the present invention to provide a quantum dot dispersion and a quantum dot ink composition that include a specific ligand compound capable of improving refractivity, thermal stability, and photostability of quantum dots.

It is another aspect of the present invention to provide a cured film, a color filter, and a display device including a cured product of the quantum dot ink composition.

However, it should be understood that the present invention is not limited to those described above. The above and other aspects of the present invention will become apparent to those skilled in the art from the detailed description of the following embodiments in conjunction with the accompanying drawings.

In accordance with one aspect of the present invention, there is provided a quantum dot dispersion including: quantum dots having a ligand layer on a surface thereof; and a photopolymerizable monomer, wherein the ligand layer includes a first ligand compound and a second ligand compound, the first ligand compound including a compound represented by Formula 1, and the second ligand compound including a compound having a terminal carboxyl group.

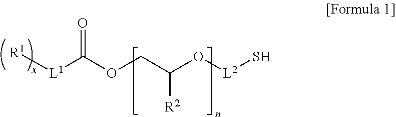

(where R¹ is a C₆ to C₂₀ aromatic hydrocarbon group;
R² is a hydrogen atom or a methyl group;
L¹ is a direct bond or a C₁ to C₁₀ bivalent aliphatic hydrocarbon group, wherein —CH₂— of the bivalent aliphatic hydrocarbon group may be substituted with —O— or —S—;
L² is a C₁ to C₁₀ bivalent aliphatic hydrocarbon group, wherein —CH₂— of the bivalent aliphatic hydrocarbon group may be substituted with —C(═O)— or —OC(═O)—, and —O-L²- includes at least one ester group;
x is an integer of 1 to 3; and
n is an integer of 1 to 20.)

In the quantum dot dispersion, the second ligand compound may include a compound having a terminal carboxyl group and a terminal (meth)acrylate group.

In the quantum dot dispersion, the quantum dots may include at least one selected from the group consisting of a Group II-VI compound, a Group III-V compound, a Group IV-VI compound, a Group IV compound, a Group I-III-VI compound, and a Group I-II-IV-VI compound

In the quantum dot dispersion, the quantum dots may be cadmium-free quantum dots.

In accordance with another aspect of the present invention, there is provided a quantum dot ink composition including the quantum dot dispersion, a photoinitiator, and scattering particles.

In the quantum dot ink composition, the photoinitiator may include at least one selected from the group consisting of a phosphine oxide compound, an acetophenone compound, a benzophenone compound, a triazine compound, a biimidazole compound, an oxime compound, and a thioxanthone compound.

In the quantum dot ink composition, the scattering particles may include at least one selected from the group consisting of Al₂O₃, SiO₂, ZnO, ZrO₂, CaCO₃, BaSO₄, BaTiO₃, TiO₂, Ta₂O₅, Ti₃O₅, ITO, IZO, ATO, ZnO—Al, Nb₂O₃, SnO, and MgO.

The quantum dot ink composition may include: 10 wt % to 60 wt % of the quantum dots having a ligand layer on a surface thereof; 30 wt % to 80 wt % of the photopolymerizable monomer; 0.01 wt % to 10 wt % of the photoinitiator; and 0.5 wt % to 15 wt % of the scattering particles, based on the total weight of the quantum dot ink composition.

In accordance with a further aspect of the present invention, there is provided a cured film including a cured product of the quantum dot ink composition.

After heat treatment at 180° C. for 5 hours, absolute quantum efficiency of the cured film having a thickness of 9.4 m may be at least 40% of that before heat treatment.

After irradiation with light having a wavelength of 450 nm at an intensity of 60 mW/cm² for 3 hours, luminance of the cured film having a thickness of 9.4 m may be at least 49.5% of that before irradiation.

In accordance with yet another aspect of the present invention, there is provided a color filter including the cured film.

In accordance with yet another aspect of the present invention, there is provided a display device including the color filter.

Embodiments of the present invention provide a quantum dot dispersion and a quantum dot ink composition containing quantum dots that include a ligand compound having an aromatic hydrocarbon group at one end and a thiol group at the other end in a ligand layer, thereby further improving refractivity, thermal stability, and photostability of the ink composition.

Embodiments of the present invention provide a quantum dot dispersion and a quantum dot ink composition offering a low viscosity suitable for excellent inkjet processability while exhibiting improved optical properties for application to high-quality displays.

### DETAILED DESCRIPTION

Unless defined otherwise herein, all terms (including technical and scientific terms) have the same meaning as commonly understood by one of ordinary skill in the art to which this disclosure pertains. Terms, such as those defined in commonly used dictionaries, should be interpreted as having a meaning that is consistent with their meaning in the context of the related art and should not be interpreted in an idealized or overly formal sense, unless clearly defined herein.

In addition, as used herein, the terms “comprises,” “comprising,” “includes,” and/or “including” specify the presence of stated elements and/or steps, but do not preclude the presence or addition of at least one other element and/or step.

Furthermore, as used herein, “(meth)acrylate” refers to acrylate and methacrylate, “(meth)acryl” refers to acryl and methacryl, and “(meth)acryloyl” refers to acryloyl and methacryloyl.

Furthermore, as used herein, the terms “monomeric product” and “monomer” have the same meaning. In the context of the invention, a monomer is distinguished from oligomers and polymers and refers to a compound having a weight average molecular weight of 1,000 g/mol or less. As used herein, “photopolymerizable monomer” refers to a monomer containing a group participating in photopolymerization, for example, a (meth)acrylate group.

### <Quantum Dot Dispersion>

The quantum dot dispersion according to the present invention is prepared for use in the preparation of a quantum dot ink composition and includes: quantum dots having a ligand layer on a surface thereof, and a photopolymerizable monomer.

In one embodiment, the quantum dot dispersion may be a solvent-free quantum dot dispersion and exhibits good dispersibility of the quantum dots and low viscosity despite the absence of a solvent.

In one embodiment, the quantum dot dispersion may be substantially free of resin components. By eliminating a resin component, the quantum dot dispersion maintains low viscosity and thus can be applied to a quantum dot ink composition with excellent inkjet processability.

### Quantum Dots

Quantum dots (QDs) are nanoscale semiconductor materials that can have different energy bandgaps depending on the size and composition thereof and thus can emit light with different emission wavelengths.

Such quantum dots may have a homogeneous monolayer structure; a multilayer structure, such as a core-shell structure, a gradient structure, and the like, or a mixture thereof. When the shell has a multilayer structure, each layer may contain a different component, for example, a metal oxide or metalloid oxide.

The quantum dots (QDs) may be freely selected from among a Group II-VI compound, a Group III-V compound, a Group IV-VI compound, a Group IV element, a Group IV compound, and combinations thereof. When the quantum dots are prepared in the form of a core-shell structure, each of the core and the shell may be freely selected from components exemplified below.

In one example, the Group II-VI compound may be selected from the group consisting of a binary compound selected from the group consisting of CdO, CdS, CdSe, CdTe, ZnO, ZnS, ZnSe, ZnTe, HgS, HgSe, HgTe, MgSe, MgS, and mixtures thereof, a ternary compound selected from the group consisting of CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and mixtures thereof, and a quaternary compound selected from the group consisting of CdZnSeS, CdZnSeTe, CdZnSTe, CdHgSeS, CdHgSeTe, CdHgSTe, HgZnSeS, HgZnSeTe, HgZnSTe, and mixtures thereof.

In another example, the Group III-V compound may be selected from the group consisting of a binary compound selected from the group consisting of GaN, GaP, GaAs, GaSb, AlN, AlP, AlAs, AlSb, InN, InP, InAs, InSb, and mixtures thereof, a ternary compound selected from the group consisting of GaNP, GaNAs, GaNSb, GaPAs, GaPSb, AlNP, AlNAs, AlNSb, AlPAs, AlPSb, InNP, InNAs, InNSb, InPAs, InPSb, and mixtures thereof, and a quaternary compound selected from the group consisting of GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, and mixtures thereof.

In another example, the Group IV-VI compound may be selected from the group consisting of a binary compound selected from the group consisting of SnS, SnSe, SnTe, PbS, PbSe, PbTe, and mixtures thereof, a ternary compound selected from the group consisting of SnSeS, SnSeTe, SnSTe, PbSeS, PbSeTe, PbSTe, SnPbS, SnPbSe, SnPbTe, and mixtures thereof, and a quaternary compound selected from the group consisting of SnPbSSe, SnPbSeTe, SnPbSTe, and mixtures thereof.

In another example, the Group IV element may be selected from the group consisting of Si, Ge, and mixtures thereof. The Group IV compound may be a binary compound selected from the group consisting of SiC, SiGe, and mixtures thereof.

The aforementioned binary, ternary, or quaternary compounds may be present within a particle at a uniform concentration or may be present within a same particle in separated regions having partially different concentration distributions. The quantum dots may also have a core/shell structure in which one quantum dot surrounds another quantum dot. The interface between the core and the shell may have a concentration gradient in which the concentration of an element in the shell gradually decreases toward the center thereof.

The quantum dots may have any shape commonly used in the art. For example, the quantum dots may have a spherical shape, a rod shape, a pyramidal shape, a disc shape, a multi-armed shape, or a cubic shape, and may be in the form of nanoparticles, nanotubes, nanowires, nanofibers, or nano-platelets.

In addition, the size of the quantum dots is not particularly limited and may be suitably adjusted within a typical range well-known in the art. For example, the quantum dots may have an average particle diameter (D50) of about 2 nm to about 10 nm. As such, when the average particle diameter of the quantum dots is adjusted within the range of about 2 nm to about 10 nm, the quantum dots can emit light of a desired color. For example, when InP-containing quantum dot core/shell has a particle diameter of about 5 nm to about 6 nm, the quantum dots can emit light having a wavelength of about 520 nm to about 550 nm. On the other hand, when the InP-containing quantum dot core/shell has a particle diameter of about 7 nm to about 8 nm, the quantum dots can emit light having a wavelength of about 620 nm to about 640 nm. For example, cadmium (Cd)-free quantum dots (QDs) (for example, InP, InGaP, InZnP, GaN, GaAs, or GaP) may be used as blue-emitting quantum dots.

In general, the quantum dots may be prepared by a wet chemical process, metal organic chemical vapor deposition (MOCVD), or molecular beam epitaxy (MBE).

The quantum dots according to the present invention may be synthesized by a wet chemical process.

The wet chemical process refers to a method of growing particles by adding precursor materials to an organic solvent. In this process, since the organic solvent is naturally coordinated on the surfaces of the quantum dot crystals and acts as a dispersant to control growth of the crystals when the quantum dot crystals grow, growth of the quantum dot particles can be controlled through an easier and cheaper process than vapor deposition methods, such as metal organic chemical vapor deposition or molecular beam epitaxy.

In preparation of the quantum dots by the wet chemical process, organic ligands are used to prevent aggregation of the quantum dots and to control the particle size of the quantum dots to nanometer precision. As such initial organic ligands, oleic acid may be generally used.

The quantum dots may have a full width at half maximum (FWHM) of about 40 nm or less in the emission spectrum. Within this range, the quantum dots can improve color purity or color reproduction. In addition, such quantum dots allow emission of light in all directions, thereby improving viewing angle.

The quantum dots may be present in an amount of 1 wt % to 99 wt %, preferably 10 wt % to 90 wt %, based on the total weight of the quantum dot dispersion.

### Ligand

The quantum dots have a ligand layer on the surface thereof and ligands included in the ligand layer serve to modify the surfaces of the quantum dots. Since hydrophobic properties of the surfaces of the quantum dots provide a barrier to dispersion of the quantum dots in the photopolymerizable monomer, miscibility of the quantum dots in the photopolymerizable monomer can be improved through surface modification of the quantum dots with suitable ligands.

The ligand layer includes a first ligand compound and a second ligand compound.

The first ligand compound includes a compound represented by Formula 1:

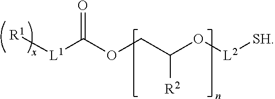

In Formula 1, R¹ may be a C₆ to C₂₀ aromatic hydrocarbon group.

The aromatic hydrocarbon group may include a phenyl group, a benzyl group, a tolyl group, a xylyl group, a naphthyl group, and the like, preferably a phenyl group, a benzyl group, or a tolyl group. The aromatic hydrocarbon group preferably has a carbon number of 6 to 15, more preferably 6 to 12, still more preferably 6 to 10.

In addition, in Formula 1, R² may be a hydrogen atom or a methyl group.

In addition, in Formula 1, L¹ may be a direct bond or a C₁ to C₁₀ bivalent aliphatic hydrocarbon group. Here, when L¹ is a C₁ to C₁₀ bivalent aliphatic hydrocarbon group, —CH₂— of the bivalent aliphatic hydrocarbon group may be substituted with —O— or —S—. Here, —CH₂— near an ester group (—COO—) is not substituted with —O— or —S—.

In addition, in Formula 1, L² may be a C₁ to C₁₀ bivalent aliphatic hydrocarbon group. Here, —CH₂— of the bivalent aliphatic hydrocarbon group may be substituted with —C(═O)— or —OC(═O)—, and —O-L²- includes at least one ester group.

The bivalent aliphatic hydrocarbon group may be a saturated or unsaturated hydrocarbon group and may be a chain or alicyclic hydrocarbon group. In addition, the alicyclic hydrocarbon group may be a monocyclic or polycyclic hydrocarbon group.

The saturated bivalent aliphatic hydrocarbon groups may include straight alkanediyl groups, such as a methylene group, an ethylene group, a propanediyl group, a butanediyl group, a pentanediyl group, a hexanediyl group, a heptanediyl group, an octanediyl group, a nonanediyl group, a decanediyl group, and the like; branched alkanediyl groups, such as an isopropanediyl group, an isobutanediyl group, an isopentanediyl group, a neopentanediyl group, a 2-ethylhexanediyl group, a sec-butanediyl group, a 1,3-dimethylbutanediyl group, a 2-ethylbutanediyl group, and the like; and alicyclic alkanediyl groups, such as a cyclopropanediyl group, a cyclopentanediyl group, a cyclohexanediyl group, a cycloheptanediyl group, a cyclooctanediyl group, a tricyclodecanediyl group, and the like.

The unsaturated bivalent aliphatic hydrocarbon groups may include a vinylene group, a propenediyl group, an isopropenediyl group, a 2-methyl-2-propenediyl group, a 1-butenediyl group, a 2-butenediyl group, a 3-butenediyl group, an isobutenediyl group, a 2-pentenediyl group, a 3-pentenediyl group, a 4-pentenediyl group, a 2-methyl-2-butenediyl group, a 3-methyl-2-butenediyl group, a 1-cyclopentenediyl group, a hexenediyl group, a 1-cyclohexenediyl group, a heptenediyl group, an octenediyl group, a nonenediyl group, a decenediyl group, and the like.

In addition, in Formula 1, x may be an integer of 1 to 3. Here, when x is 2 or 3, plural R¹s may be identical or different from each other.

In addition, in Formula 1, n may be an integer of 1 to 20, preferably 1 to 15, more preferably 2 to 12.

The first ligand compound is characterized by having an aromatic hydrocarbon group at one end thereof and a thiol group at the other end thereof, with at least two ester groups incorporated into the molecular structure thereof.

It is believed that the aromatic hydrocarbon group at one end of the molecular structure of the first ligand compound serves to increase structural stability of the ligand compound, which in turn enhances thermal and photostability of the quantum dots.

In addition, it is believed that the thiol group at the other end of the molecular structure of the first ligand compound provides excellent affinity with the surfaces of the quantum dots, which in turn improves dispersibility of the quantum dots in a polar photopolymerizable monomer.

Furthermore, it is believed that the two or more ester groups incorporated into the molecular structure of the first ligand compound improve dispersibility of the quantum dots in a polar photopolymerizable monomer and increase structural stability of the first ligand compound under high temperature/light intensity conditions, which in turn improves thermal and photostability of the quantum dots. Furthermore, the two or more ester groups incorporated into the molecular structure of the first ligand compound facilitate synthesis of the ligand compound while ensuring high yield and ligand diversity.

In one embodiment, the first ligand compound may include a metal complex consisting of the compound represented by Formula 1 and a metal.

The metal may be a divalent to tetravalent metal, for example, Mg, Ca, Sc, Ti, V, Cr, Mn, Fe, Co, Ni, Cu, Zn, Ga, Ge, Sr, Mo, Pd, Cd, In, or Sn, preferably Zn.

The second ligand compound includes a compound having a terminal carboxyl group.

If the surface of the quantum dot contains only the first ligand compound, which is a thiol ligand, there can be problems of generation of harmful odors or poor storage stability through increase in viscosity. Accordingly, the ligand layer further includes the second ligand compound that does not contain a thiol group on the surface of the quantum dot, thereby preventing generation of harmful odors and viscosity increase while improving storage stability. Furthermore, the second ligand compound has a terminal carboxyl group, which in turn improves the dispersibility of the quantum dots in a polar photopolymerizable monomer.

In one embodiment, the second ligand compound may include a compound having a terminal carboxyl group and a terminal (meth)acrylate group, thereby further improving the dispersibility of the quantum dots in an acrylate photopolymerizable monomer, which is preferable.

In one embodiment, the second ligand compound may include a compound represented by Formula 2:

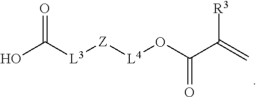

In Formula 2, L³ and L⁴ are each independently a direct bond or a C₁ to C₁₀ bivalent aliphatic hydrocarbon group, preferably a C₁ to C₆ bivalent aliphatic hydrocarbon group, more preferably a C₁ to C₄ bivalent aliphatic hydrocarbon group. Examples of the bivalent aliphatic hydrocarbon group are the same as above.

In addition, in Formula 2, Z may be a direct bond, —OC(═O)—, —C(═O)O—, —HNC(═O)—, —C(═O)NH—, —C(═O)—, or —O—, preferably —OC(═O)—, —C(═O)O—, —HNC(═O)—, or —C(═O)NH—, more preferably —OC(═O)— or —C(═O)O—.

In addition, in Formula 2, R³ is a hydrogen atom or a methyl group.

In one embodiment, the second ligand compound may be a C₆ to C₁₅ compound, preferably a C₆ to C₁₂ compound, more preferably a C₆ to C₁₀ compound. This range of the carbon number of the second ligand compound allows efficient surface modification of the quantum dots without deterioration in dispersibility of the quantum dots in the photopolymerizable monomer.

In one embodiment, the first ligand compound and the second ligand compound may be present in a mole ratio of 1:0.1 to 20, preferably 1:0.2 to 10, more preferably 1:0.5 to 5.

Furthermore, in one embodiment, the quantum dots and the ligand compound may be present in a weight ratio of 1:0.05 to 1, preferably 1:0.1 to 0.6, more preferably 1:0.2 to 0.4. Here, the weight of the ligand compound refers to the sum of the weight of the first ligand compound and the weight of the second ligand compound. This range of the weight ratio of the quantum dots to the ligand compound allows improvement in miscibility of the quantum dots in the photopolymerizable monomer through surface modification of the quantum dots while further improving thermal and photostability.

### Photopolymerizable Monomer

The photopolymerizable monomer controls a formulation in which the quantum dots are dispersed, that is, the overall crosslinking density of a polymer matrix to realize the structure and other properties of the matrix. The photopolymerizable monomer can also improve flexibility and adhesion to other materials.

The photopolymerizable monomer may include at least one selected from the group consisting of mono- to hexa-functional (meth)acrylate compounds. The mono- to hexafunctional (meth)acrylate compounds may be any monomers typically used in the art, without limitation.

Examples of the monofunctional (meth)acrylate compound may include methyl (meth)acrylate, ethyl (meth)acrylate, propyl (meth)acrylate, butyl (meth)acrylate, hexyl (meth)acrylate, cyclohexyl (meth)acrylate, 2-ethylhexyl (meth)acrylate, lauryl (meth)acrylate, stearyl (meth)acrylate, octadecyl (meth)acrylate, isooctyl (meth)acrylate, isononyl (meth)acrylate, isodecyl (meth)acrylate, isobornyl (meth)acrylate, and the like.

Examples of the bifunctional (meth)acrylate compound may include 1,6-hexanediol di(meth)acrylate, ethylene glycol di(meth)acrylate, neopentyl glycol di(meth)acrylate, 3-methylpentanediol di(meth)acrylate, triethylene glycol di(meth)acrylate, and the like, preferably 1,6-hexanediol di(meth)acrylate.

Examples of the tri- to hexa-functional (meth)acrylate compounds may include trimethylolpropane tri(meth)acrylate, ethoxylated trimethylolpropane tri(meth)acrylate, propoxylated trimethylolpropane tri(meth)acrylate, ditrimethylolpropane tetra(meth)acrylate, pentaerythritol tri(meth)acrylate, pentaerythritol tetra(meth)acrylate, dipentaerythritol tri(meth)acrylate, dipentaerythritol penta(meth)acrylate, ethoxylated dipentaerythritol hexa(meth)acrylate, propoxylated dipentaerythritol hexa(meth)acrylate, dipentaerythritol hexa(meth)acrylate, and the like.

On the other hand, although the monofunctional (meth)acrylate compound generally has a small molecular weight, which is advantageous for controlling the viscosity of the quantum dot ink composition, the volatility of the monofunctional (meth)acrylate compound increases at high temperature, which in turn promotes outgassing in high-temperature processes, such as post-baking, thereby causing defects, such as cracks in the coating film. Therefore, it may be desirable that the photopolymerizable compound include at least one selected from the di- to hexa-functional (meth)acrylate compounds.

Furthermore, although an increase in the number of functional groups of the (meth)acrylate compound generally increases the molecular weight thereof, which in turn reduces outgassing during high-temperature processes, it can also increase the viscosity of the quantum dot ink composition, thereby compromising inkjet processability and storage stability. In this respect, the photopolymerizable compound preferably includes at least one selected from the di- to tri-functional (meth)acrylate compounds, more preferably a bifunctional (meth)acrylate compound, most preferably 1,6-hexanediol diacrylate.

The photopolymerizable monomer may be present in an amount of 1 wt % to 99 wt %, preferably 10 wt % to 90 wt %, based on the total weight of the quantum dot dispersion.

### <Quantum Dot Ink Composition>

The quantum dot ink composition according to the present invention includes the quantum dot dispersion, the photoinitiator, and the scattering particles described above, and may further include at least one selected from the group consisting of the photopolymerizable monomer, a polymerization inhibitor, and other additives as desired.

For the quantum dots and the photopolymerizable monomer included in the quantum dot ink composition, refer to the description of <Quantum dot dispersion>.

The quantum dots may be present in an amount of 1 wt % to 60 wt %, preferably 20 wt % to 45 wt %, based on the total weight of the quantum dot ink composition.

The photopolymerizable monomer may be present in an amount of 30 wt % to 80 wt %, preferably 40 wt % to 70 wt %, based on the total weight of the quantum dot ink composition.

In one embodiment, the quantum dot ink composition may be a solvent-free quantum dot ink composition and exhibits good dispersibility of the quantum dots and low viscosity despite the absence of a solvent. Furthermore, the quantum dot ink composition may be suitable for an inkjet printing applications.

In one embodiment, the quantum dot ink composition may be substantially free of a resin component. By eliminating a resin component, the quantum dot ink composition maintains low viscosity and thus can exhibit excellent inkjet processability.

### Photoinitiator

The photoinitiator serves to initiate photopolymerization through excitation by light, such as ultraviolet (UV) light, and may be any typical photoinitiator used in the art.

In one embodiment, the photoinitiator may include at least one selected from the group consisting of a phosphine oxide compound, an acetophenone compound, a benzophenone compound, a triazine compound, a biimidazole compound, an oxime compound, and a thioxanthone compound.

Examples of the phosphine oxide compound may include bis(2,4,6-trimethylbenzoyl)phenylphosphine oxide, trimethylbenzoylphenylphosphine oxide, ethyl(2,4,6-trimethylbenzoyl)phenylphosphinate, diphenyl(2,4,6-trimethylbenzoyl)phosphine oxide, and the like. As a commercially available phosphine oxide compound, TPO-L (IGM) may be used.

Examples of the acetophenone compound may include diethoxyacetophenone, 2-hydroxy-2-methyl-1-phenylpropan-1-one, benzyl dimethyl ketal, 2-hydroxy-1-[4-(2-hydroxyethoxy)phenyl]-2-methylpropan-1-one, 1-hydroxycyclohexylphenylketone, 2-methyl-1-(4-methylthiophenyl)-2-morpholinopropan-1-one, 2-benzyl-2-dimethylamino-1-(4-morpholinophenyl)butan-1-one, 2-hydroxy-2-methyl-1-[4-(1-methylvinyl)phenyl]propan-1-one, 2-(4-methylbenzyl)-2-(dimethylamino)-1-(4-morpholinophenyl)butan-1-one, and the like.

Examples of the benzophenone compound may include benzophenone, methyl o-benzoylbenzoate, 4-phenylbenzophenone, 4-benzoyl-4′-methyldiphenylsulfide, 3,3′,4,4′-tetra(tert-butylperoxycarbonyl)benzophenone, 2,4,6-trimethylbenzophenone, and the like.

Examples of the triazine compound may include 2,4-bis(trichloromethyl)-6-(4-methoxyphenyl)-1,3,5-triazine, 2,4-bis(trichloromethyl)-6-(4-methoxynaphthyl)-1,3,5-triazine, 2,4-bis(trichloromethyl)-6-piperonyl-1,3,5-triazine, 2,4-bis(trichloromethyl)-6-(4-methoxystyryl)-1,3,5-triazine, 2,4-bis(trichloromethyl)-6-[2-(5-methylfuran-2-yl)ethenyl]-1,3,5-triazine, 2,4-bis(trichloromethyl)-6-[2-(furan-2-yl)ethenyl]-1,3,5-triazine, 2,4-bis(trichloromethyl)-6-[2-(4-diethylamino-2-methylphenyl)ethenyl]-1,3,5-triazine, 2,4-bis(trichloromethyl)-6-[2-(3,4-dimethoxyphenyl)ethenyl]-1,3,5-triazine, and the like.

Examples of the biimidazole compound may include 2,2′-bis(2-chlorophenyl)-4,4′,5,5′-tetraphenylbiimidazole, 2,2′-bis(2,3-dichlorophenyl)-4,4′,5,5′-tetraphenylbiimidazole, 2,2′-bis(2-chlorophenyl)-4,4′,5,5′-tetra(alkoxyphenyl)biimidazole, 2,2′-bis(2-chlorophenyl)-4,4′,5,5′-tetra(trialkoxyphenyl)biimidazole, 2,2-bis(2,6-dichlorophenyl)-4,4′,5,5′-tetraphenyl-1,2′-biimidazole, biimidazole compounds in which a phenyl group at the 4,4′,5,5′ position is substituted with a carboalkoxy group, and the like. Among these compounds, 2,2′-bis(2-chlorophenyl)-4,4′,5,5′-tetraphenylbiimidazole, 2,2′-bis(2,3-dichlorophenyl)-4,4′,5,5′-tetraphenylbiimidazole, and 2,2-bis(2,6-dichlorophenyl)-4,4′,5,5′-tetraphenyl-1,2′-biimidazole are preferably used.

Examples of the oxime compound may include o-ethoxycarbonyl-a-oxyimino-1-phenylpropan-1-one, 2-((benzoyloxy)imino)-1-(4-(phenylthio)phenyl)octan-1-one, and the like. As a commercially available oxime compound, Irgacure OXE 01 and OXE 02 (BASF) may be used.

Examples of the thioxanthone compound may include 2-isopropylthioxanthone, 2,4-diethylthioxanthone, 2,4-dichlorothioxanthone, 1-chloro-4-propoxythioxanthone, and the like.

The photoinitiator may be present in an amount of 0.01 wt % to 10 wt %, preferably 0.1 wt % to 5 wt %, based on the total weight of the quantum dot ink composition.

### Scattering Particles

The scattering particles serve to increase an optical path of light emitted from a light source, thereby increasing the overall photoconversion rate of light-scattering pixels.

The scattering particles may be selected from any typical inorganic materials, preferably metal oxides.

The scattering particles may include at least one selected from the group consisting of, for example, Al₂O₃, SiO₂, ZnO, ZrO₂, CaCO₃, BaSO₄, BaTiO₃, TiO₂, Ta₂O₅, Ti₃O₅, ITO, IZO, ATO, ZnO—Al, Nb₂O₃, SnO, and MgO, preferably at least one selected from the group consisting of CaCO₃, BaSO₄, TiO₂, and ZrO₂, more preferably TiO₂.

The scattering particles may have a primary average particle diameter (D90) of 300 nm or less, preferably 150 nm to 250 nm, more preferably 180 nm to 230 nm, without being limited thereto.

The scattering particles may be present in an amount of 0.5 wt % to 15 wt %, preferably 1 wt % to 10 wt %, based on the total weight of the quantum dot ink composition.

### Polymerization Inhibitor

The polymerization inhibitor is a substance that reacts with radicals to form a low reactivity radical or compound that cannot cause polymerization reaction, and may be added to control the photopolymerization rate.

The polymerization inhibitor may be any substance known in the art without limitation. For example, the polymerization inhibitor may include quinone compounds, phenolic or aniline compounds, aromatic nitro or nitroso compounds, and the like. These compounds may be used alone or as a mixture thereof.

Specifically, the quinone compounds may include hydroquinone (HQ), methyl hydroquinone (THQ), hydroquinone monomethyl ether (MEHQ), hydroquinone monoethyl ether (EEHQ), 1,4-benzoquinone (BQ), 2,5-diphenylbenzoquinone (DPBQ), methyl-1,4-benzoquinone (MBQ), phenyl-1,4-benzoquinone (PBQ), and the like.

The phenolic or aniline compounds may include 2,6-di-tert-butyl-4-methylphenol (BHT), 2,6-diphenyl-4-octadecyloxyphenol, catechol, and the like.

The aromatic nitro or nitroso compounds may include phenothiazine, bis(a-methylbenzyl)phenothiazine, 3,7-dioctylphenothiazine, bis(α,α-dimethylbenzyl)phenothiazine, dimethyldithiocarbamic acid, diethyldithiocarbamic acid, dipropyl dithiocarbamic acid, dibutyl dithiocarbamic acid, diphenyldithiocarbamic acid, and the like.

The polymerization inhibitor may be present in an amount of 0.01 wt % to 2 wt %, preferably 0.05 wt % to 1 wt %, based on the total weight of the quantum dot ink composition.

### Other Additives

In addition to the aforementioned components, the quantum dot ink composition may include additives known in the art, as needed. Here, the content of each additive may be suitably adjusted within the range known in the art.

Examples of the additives include silane compounds, siloxane compounds, antioxidants, polymerization inhibitors, lubricants, surface modifiers, surfactants, adhesion enhancers, defoaming agents, slip agents, solvents, wetting agents, light stabilizers, stain inhibitors, softeners, thickeners, polymers, and the like. These additives may be used alone or as a mixture thereof.

The silane compound serves to impart adhesion to the matrix and the siloxane compound serves to impart wetting properties. The silane compound and the siloxane compound may be selected from typical compounds known in the art.

The antioxidant serves to inhibit discoloration due to heat or irradiation with light and discoloration due to various oxidizing gases, such as ozone, reactive oxygen species, NOx, SOx (where x is an integer), and the like. According to the present invention, the antioxidant can prevent discoloration of the matrix or can suppress reduction in film thickness due to decomposition. Examples of the antioxidant include hydrazides, hindered amine antioxidants, nitrogen-containing heterocyclic mercapto compounds, thioether antioxidants, hindered phenol antioxidants, ascorbic acid, zinc sulfate, thiocyanates, thiourea derivatives, sugars, nitrites, sulfites, thiosulfates, hydroxylamine derivatives, and the like.

The leveling agent may be used to further enhance adhesion of the ink composition by leveling the quantum dot ink composition such that the quantum dot ink composition can be coated flatly and evenly. The leveling agent may include an acrylic compound, a silicone compound, or a mixture thereof. For example, the leveling agent may include polyether-modified polydimethylsiloxane containing a (meth)acryloyl group added to the polyether chain thereof.

The surfactant may be used for miscibility and coating uniformity of the quantum dot ink composition. The surfactant may be selected from among typical cationic, anionic, amphoteric, and non-ionic surfactants known in the art. For example, the surfactant may include at least one selected from among a fluorinated surfactant, a silicone surfactant, and a fluorosilicone surfactant.

The light stabilizer is a UV absorbent and has an effect of increasing weather resistance of the matrix. The softener serves to mitigate occurrence of cracks in the dried polymer matrix and can improve impact resistance and flexural resistance by mitigating occurrence of cracks within a cured matrix.

### <Cured Film, Color Filter and Display Device>

The present invention provides a cured film including a cured product of the quantum dot ink composition. The cured film may be manufactured by applying the quantum dot ink composition to a substrate by an inkjet jetting method to form a predetermined pattern on the substrate; and curing the pattern.

The substrate may be a substrate having a flat surface, for example, a glass substrate, a silicon substrate, a polycarbonate substrate, a polyester substrate, an aromatic polyamide substrate, a polyamideimide substrate, a polyimide substrate, an Al substrate, a GaAs substrate, and the like, without being limited thereto. The substrate may be subjected to pretreatment, such as chemical treatment with a silane coupling agent, plasma treatment, ion plating, sputtering, gas phase reaction, vacuum deposition, and the like. Further, the substrate may have a partition matrix formed thereon.

In one embodiment, after heat treatment at 180° C. for 5 hours, absolute quantum efficiency of the cured film having a thickness of 9.4 m may be at least 40%, preferably at least 50%, more preferably at least 52.3% of that before heat treatment.

In one embodiment, after irradiation with light having a wavelength of 450 nm at an intensity of 60 mW/cm² for 3 hours, luminance of the cured film having a thickness of 9.4 m may be at least 49.5%, preferably at least 52%, more preferably at least 53.3% of that before irradiation.

In addition, the present invention provides a color filter including the cured film. The color filter may include a pixel layer formed by depositing the quantum dot ink composition onto a substrate in a predetermined pattern, followed by curing. The composition and manufacturing method of the color filter are well known in the art and will not be described in detail.

In addition, the present invention provides a display device including the color filter. The display device may include a liquid crystal display (LCD), an electroluminescent (EL) display, a plasma display panel (PDP), a field emission display (FED), an organic light emitting diode (OLED) display, and the like, without being limited thereto. The display device according to the present invention may further include a blue light source together with the color filter, and may include configurations known in the art, as needed.

Next, the present invention will be described in more detail with reference to some examples. It should be understood that these examples are provided for illustration only and are not to be construed in any way as limiting the invention.

### EXAMPLE

### Synthesis Example 1: Synthesis of InZnP/ZnSe/ZnS Quantum Dot

1) In a 200 ml flask, zinc acetate and oleic acid were dissolved in 1-octadecene, heated to 120° C. under vacuum, and cooled to room temperature, thereby obtaining a zinc oleate solution.

2) In a reaction flask, indium acetate and lauric acid were heated together with the zinc oleate to 120° C. under vacuum. Here, the mole ratio of indium to lauric acid was set to 1:3. After 1 hour, with the interior atmosphere of the reactor substituted with nitrogen, a mixed solution of tris(trimethylsilyl) phosphine (TMS₃P) and trioctyl phosphine (TOP) and the zinc oleate solution were rapidly injected into the reaction flask while raising the temperature of the reaction flask to 250° C.

3) During reaction, an indium oleate solution, the TMS₃P mixed solution, and zinc oleate were sequentially added to the reaction flask, and reacted for 30 min, thereby forming InZnP cores.

4) Se was dispersed in TOP at 120° C. to prepare a Se/TOP solution. S was dispersed in TOP to prepare an S/TOP solution.

5) In a 300 ml reactor, zinc acetate and oleic acid were dissolved in trioctylamine and left under vacuum at 120° C. for 10 min to prepare a zinc precursor. After creating a nitrogen atmosphere in the flask, the temperature of the flask was raised to 280° C. and maintained for a predetermined period of time.

6) The prepared InZnP core and Se/TOP were added in a predetermined ratio and then heated to a high temperature of 300° C. or more for reaction to form a ZnSe-containing layer.

7) When the Se precursor was exhausted, S/TOP and 0.07 mmol of ZnCl₂ were simultaneously injected into the reactor. A ZnS-containing layer containing zinc sulfide was formed by reacting for a total of 1 hour.

8) InZnP/ZnSe/ZnS quantum dot powder was prepared by separating and purifying the synthesized quantum dots.

### Synthesis Example 2: Synthesis of Ligand Compound A-1

### 1) Step 1

1.3 g of 4-(dimethylamino)pyridine and 22.16 g of 1,3-dicyclohexyl carbodiimide were added to a solution prepared by dissolving 20 g of 1-naphthaleneacetic acid and 20.86 g of tetraethylene glycol in 350 ml of dichloromethane, followed by stirring the resulting solution under a nitrogen atmosphere for 1 hour. After completion of the reaction, the resulting product was extracted and neutralized. After neutralization, residual moisture was removed from the extracted product using anhydrous magnesium sulfate, followed by concentration using a vacuum evaporator.

### 2) Step 2

0.52 g of p-toluenesulfonic acid was added to a solution prepared by dissolving 10 g of the resulting product of Step 1 and 2.54 g of thioglycolic acid in 350 ml of cyclohexane, followed by stirring the resulting solution at 80° C. for 12 hours. After completion of the reaction, the resulting product was extracted and neutralized. After neutralization, residual moisture was removed from the extracted product using anhydrous magnesium sulfate, followed by concentration using a vacuum evaporator, thereby obtaining ligand compound A-1 represented by Formula 1-1:

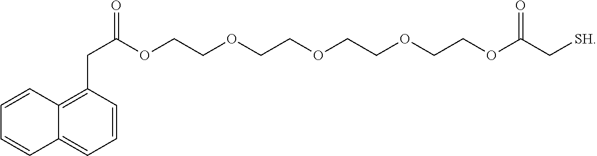 [SMILES: O=C(CS)OCCOCCOCCOCCOC(=O)Cc1cccc2ccccc12]

### Synthesis Example 3: Synthesis of Ligand Compound A-2

### 1) Step 1

1.45 g of 4-(dimethylamino)pyridine and 24.53 g of 1,3-dicyclohexyl carbodiimide were added to a solution prepared by dissolving 20 g of (phenylthio)acetic acid and 23.1 g of tetraethylene glycol in 350 ml of dichloromethane, followed by stirring the resulting solution under a nitrogen atmosphere for 1 hour. After completion of the reaction, the resulting product was extracted and neutralized. After neutralization, residual moisture was removed from the extracted product using anhydrous magnesium sulfate, followed by concentration using a vacuum evaporator.

### 2) Step 2

1.1 g of p-toluenesulfonic acid was added to a solution prepared by dissolving 20 g of the resulting product of Step 1 and 5.46 g of thioglycolic acid in 350 ml of cyclohexane, followed by stirring the resulting solution at 80° C. for 12 hours. After completion of the reaction, the resulting product was extracted and neutralized. After neutralization, residual moisture was removed from the extracted product using anhydrous magnesium sulfate, followed by concentration using a vacuum evaporator, thereby obtaining ligand compound A-2 represented by Formula 1-2:

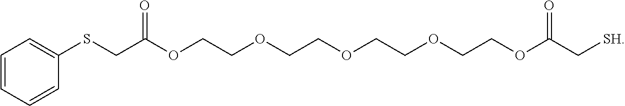 [SMILES: O=C(CS)OCCOCCOCCOCCOC(=O)CSc1ccccc1]

### Synthesis Example 4: Synthesis of Ligand Compound A-3

### 1) Step 1

1.15 g of 4-(dimethylamino)pyridine and 19.44 g of 1,3-dicyclohexyl carbodiimide were added to a solution prepared by dissolving 20 g of diphenylacetic acid and 22.88 g of tetraethylene glycol in 350 ml of dichloromethane, followed by stirring the resulting solution under a nitrogen atmosphere for 1 hour. After completion of the reaction, the resulting product was extracted and neutralized. After neutralization, residual moisture was removed using anhydrous magnesium sulfate and concentrated using a vacuum evaporator.

### 2) Step 2

0.98 g of p-toluenesulfonic acid was added to a solution prepared by dissolving 20 g of the resulting product of Step 1 and 4.75 g of thioglycolic acid in 350 ml of cyclohexane, followed by stirring the resulting solution at 80° C. for 12 hours. After completion of the reaction, the resulting product was extracted and neutralized. After neutralization, residual moisture was removed from the extracted product using anhydrous magnesium sulfate, followed by concentration using a vacuum evaporator, thereby obtaining ligand compound A-3 represented by Formula 1-3:

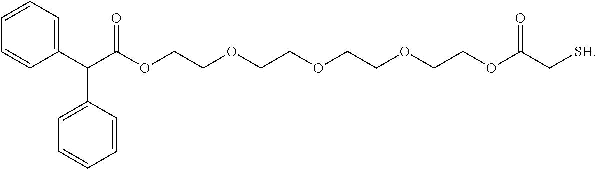 [SMILES: O=C(CS)OCCOCCOCCOCCOC(=O)C(c1ccccc1)c1ccccc1]

### Synthesis Example 5: Synthesis of Ligand Compound A-4

### 1) Step 1

1.65 g of 4-(dimethylamino)pyridine and 27.85 g of 1,3-dicyclohexyl carbodiimide were added to a solution prepared by dissolving 20 g of trans-cinnamic acid and 26.22 g of tetraethylene glycol in 350 ml of dichloromethane, followed by stirring the resulting solution under a nitrogen atmosphere for 1 hour. After completion of the reaction, the resulting product was extracted and neutralized. After neutralization, the residual moisture was removed using anhydrous magnesium sulfate and concentrated using a vacuum evaporator.

### 2) Step 2

0.59 g of p-toluenesulfonic acid was added to a solution prepared by dissolving 10 g of the resulting product of Step 1 and 2.84 g of thioglycolic acid in 350 ml of cyclohexane, followed by stirring the resulting solution at 80° C. for 12 hours. After completion of the reaction, the resulting product was extracted and neutralized. After neutralization, residual moisture was removed from the extracted product using anhydrous magnesium sulfate, followed by concentration using a vacuum evaporator, thereby obtaining ligand compound A-4 represented by Formula 1-4:

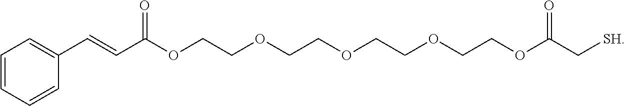 [SMILES: O=C(/C=C/c1ccccc1)OCCOCCOCCOCCOC(=O)CS]

### Synthesis Example 6: Synthesis of Ligand Compound A-5

### 1) Step 1

2 g of 4-(dimethylamino)pyridine and 33.8 g of 1,3-dicyclohexyl carbodiimide were added to a solution prepared by dissolving 20 g of benzoic acid and 31.8 g of tetraethylene glycol in 350 ml of dichloromethane, followed by stirring the resulting solution under a nitrogen atmosphere for 1 hour. After completion of the reaction, the resulting product was extracted and neutralized. After neutralization, residual moisture was removed using anhydrous magnesium sulfate and concentrated using a vacuum evaporator.

### 2) Step 2

0.64 g of p-toluenesulfonic acid was added to a solution prepared by dissolving 10 g of the resulting product of Step 1 and 3.1 g of thioglycolic acid in 350 ml of cyclohexane, followed by stirring the resulting solution at 80° C. for 12 hours. After completion of the reaction, the resulting product was extracted and neutralized. After neutralization, residual moisture was removed from the extracted product using anhydrous magnesium sulfate, followed by concentration using a vacuum evaporator, thereby obtaining ligand compound A-5 represented by Formula 1-5:

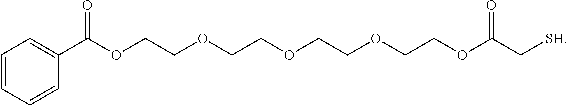 [SMILES: O=C(CS)OCCOCCOCCOCCOC(=O)c1ccccc1]

### Comparative Synthesis Example 1: Synthesis of Ligand Compound a-1

4.1 g of p-toluenesulfonic acid was added to a solution prepared by dissolving 121.8 g of polyoxyethylene monomethyl ether (MPEG-550, Green Chemicals Co., Ltd.) and 20 g of thioglycolic acid in 350 ml of toluene, followed by stirring the resulting solution at 105° C. for 18 hours. After completion of the reaction, the resulting product was extracted and neutralized. After neutralization, residual moisture was removed from the extracted product using anhydrous magnesium sulfate, followed by concentration using a vacuum evaporator, thereby obtaining ligand compound a-1 represented by Formula 3:

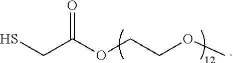

### Comparative Synthesis Example 2: Synthesis of Ligand Compound a-2

2.5 g of p-toluenesulfonic acid was added to a solution prepared by dissolving 20 g of thiomalic acid and 75.6 g of polyoxyethylene phenyl ether (PH-400, Green Chemicals Co., Ltd.) in 350 ml of toluene, followed by stirring the resulting solution at 115° C. for 12 hours. After completion of the reaction, the resulting product was extracted and neutralized. After neutralization, residual moisture was removed from the extracted product using anhydrous magnesium sulfate, followed by concentration using a vacuum evaporator, thereby obtaining ligand compound a-2 represented by Formula 4:

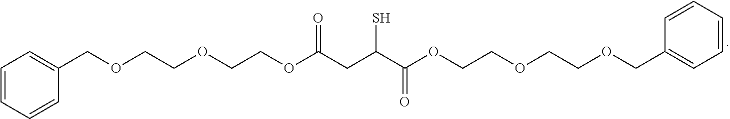 [SMILES: O=C(CC(S)C(=O)OCCOCCOCc1ccccc1)OCCOCCOCc1ccccc1]

### Example 1: Preparation of Quantum Dot Dispersion 1 and Quantum Dot Ink Composition 1

### 1.1 Surface Modification of Quantum Dots

1) A quantum dot dispersion was prepared by dispersing the quantum dot powder prepared in Synthesis Example 1 in cyclohexyl acetate.

2) A mixture of 1.04 g of ZnCl₂ and 10 g of the ligand compound A-1 prepared in Synthesis Example 2 was stirred until the resulting solution became transparent. Then, HCl gas was removed under vacuum and the resulting product was dispersed in cyclohexyl acetate, thereby obtaining a dispersion of the zinc-substituted ligand compound A-1.

3) A MAES (mono(2-acryloyloxyethyl)succinate) dispersion was prepared by dispersing MAES in cyclohexyl acetate.

4) 4.8 g of the dispersion of zinc-substituted ligand compound A-1 (0.96 g of the zinc-substituted ligand compound A-1) was injected into the quantum dot dispersion (8 g of the quantum dot powder), followed by stirring under a nitrogen atmosphere at 60° C. for 30 min.

5) 8 g of the MAES dispersion (1.6 g of MAES) was added to the resulting solution, which in turn was stirred under a nitrogen atmosphere at 60° C. for 30 min, followed by cooling the resulting solution to room temperature.

6) The resulting solution was mixed with cyclohexane and ethanol in a certain proportion, followed by centrifugation twice, thereby obtaining surface-modified quantum dot powder.

### 1.2 Preparation of Quantum Dot Dispersion

The surface-modified quantum dot powder was dried in a vacuum oven and dispersed at 50 wt % in 1,6-hexanediol diacrylate, thereby obtaining quantum dot dispersion 1.

### 1.3 Preparation of Quantum Dot Ink Composition

1) A TiO₂ dispersion (50 wt % in 1,6-hexanediol diacrylate) was prepared while ensuring the particle size (D90) did not exceed 300 nm.

2) Quantum dot ink composition 1 was prepared by mixing 5.18 g of the surface-modified quantum dot dispersion 1, 0.57 g of the TiO₂ dispersion, 0.09 g of TPO-L, and 1.12 g of 1,6-hexanediol diacrylate.

### Example 2: Preparation of Quantum Dot Dispersion 2 and Quantum Dot Ink Composition 2

### 2.1 Surface Modification of Quantum Dots

Surface-modified quantum dot powder was prepared in the same manner as in 1.1 of Example 1 except that the ligand compound A-2 prepared in Synthesis Example 3 was used instead of the ligand compound A-1 prepared in Synthesis Example 2.

### 2.2 Preparation of Quantum Dot Dispersion

Quantum dot dispersion 2 was prepared in the same manner as in 1.2 of Example 1 except that the surface-modified quantum dot powder prepared in 2.1 of Example 2 was used.

### 2.3 Preparation of Quantum Dot Ink Composition

Quantum dot ink composition 2 was prepared in the same manner as in 1.3 of Example 1 except that the quantum dot dispersion 2 prepared in 2.2 of Example 2 was used.

### Example 3: Preparation of Quantum Dot Dispersion 3 and Quantum Dot Ink Composition 3

### 3.1 Surface Modification of Quantum Dots

Surface-modified quantum dot powder was prepared in the same manner as in 1.1 of Example 1 except that the ligand compound A-3 prepared in Synthesis Example 4 was used instead of the ligand compound A-1 prepared in Synthesis Example 2.

### 3.2 Preparation of Quantum Dot Dispersion

Quantum dot dispersion 3 was prepared in the same manner as in 1.2 of Example 1 except that the surface-modified quantum dot powder prepared in 3.1 of Example 3 was used.

### 3.3 Preparation of Quantum Dot Ink Composition

Quantum dot ink composition 3 was prepared in the same manner as in 1.3 of Example 1 except that the quantum dot dispersion 3 prepared in 3.2 of Example 3 was used.

### Example 4: Preparation of Quantum Dot Dispersion 4 and Quantum Dot Ink Composition 4

### 4.1 Surface Modification of Quantum Dots

Surface-modified quantum dot powder was prepared in the same manner as in 1.1 of Example 1 except that the ligand compound A-4 prepared in Synthesis Example 5 was used instead of the ligand compound A-1 prepared in Synthesis Example 2.

### 4.2 Preparation of Quantum Dot Dispersion

Quantum dot dispersion 4 was prepared in the same manner as in 1.2 of Example 1 except that the surface-modified quantum dot powder prepared in 4.1 of Example 4 was used.

### 4.3 Preparation of Quantum Dot Ink Composition

Quantum dot ink composition 4 was prepared in the same manner as in 1.3 of Example 1 except that the quantum dot dispersion 4 prepared in 4.2 of Example 4 was used.

### Example 5: Preparation of Quantum Dot Dispersion 5 and Quantum Dot Ink Composition 5

### 5.1 Surface Modification of Quantum Dots

Surface-modified quantum dot powder was prepared in the same manner as in 1.1 of Example 1 except that the ligand compound A-5 prepared in Synthesis Example 6 was used instead of the ligand compound A-1 prepared in Synthesis Example 2.

### 5.2 Preparation of Quantum Dot Dispersion

Quantum dot dispersion 5 was prepared in the same manner as in 1.2 of Example 1 except that the surface-modified quantum dot powder prepared in 5.1 of Example 5 was used.

### 5.3 Preparation of Quantum Dot Ink Composition

Quantum dot ink composition 5 was prepared in the same manner as in 1.3 of Example 1 except that the quantum dot dispersion 5 prepared in 5.2 of Example 5 was used.

### Comparative Example 1: Preparation of Quantum Dot Dispersion 6 and Quantum Dot Ink Composition 6

### 6.1 Surface Modification of Quantum Dots

Surface-modified quantum dot powder was prepared in the same manner as in 1.1 of Example 1 except that the ligand compound a-1 prepared in Comparative Synthesis Example 1 was used instead of the ligand compound A-1 prepared in Synthesis Example 2.

### 6.2 Preparation of Quantum Dot Dispersion

Quantum dot dispersion 6 was prepared in the same manner as in 1.2 of Example 1 except that the surface-modified quantum dot powder prepared in 6.1 of Comparative Example 1 was used.

### 6.3 Preparation of Quantum Dot Ink Composition

Quantum dot ink composition 6 was prepared in the same manner as in 1.3 of Example 1 except that quantum dot dispersion 6 prepared in 6.2 of Comparative Example 1 was used.

### Comparative Example 2: Preparation of Quantum Dot Dispersion 7 and Quantum Dot Ink Composition 7

### 7.1 Surface Modification of Quantum Dots

Surface modified quantum dot powder was prepared in the same manner as in 1.1 of Example 1 except that the ligand compound a-2 prepared in Comparative Synthesis Example 2 was used instead of the ligand compound A-1 prepared in Synthesis Example 2.

### 7.2 Preparation of Quantum Dot Dispersion

Quantum dot dispersion 7 was prepared in the same manner as in 1.2 of Example 1 except that the surface-modified quantum dot powder prepared in 7.1 of Comparative Example 2 was used.

### 7.3 Preparation of Quantum Dot Ink Composition

Quantum dot ink composition 7 was prepared in the same manner as in 1.3 of Example 1 except that the quantum dot dispersion 7 prepared in 7.2 of Comparative Example 2 was used.

### Experimental Example

### 1. Evaluation of Thermal Stability

Each of the quantum dot ink compositions 1 to 7 prepared in Examples 1 to 5 and Comparative Examples 1 and 2 was deposited to a thickness of 9.4 m on a glass substrate using a spin coater (Opticoat MS-A150, Mikasa), and cured by exposure at 4,000 mJ (room temperature, 4 sec) using a 395 nm UV exposer. After curing, while heat treatment was performed at 180° C. for 5 hours, the absolute quantum efficiency was measured at intervals of 30 min to 1 hour using a measurement instrument (QE-2100, Otsuka). Results are shown in Table 1.

TABLE 1

| (Unit: %) | 0 h | 0.5 h | 1 h | 2 h | 3 h | 4 h | 5 h |
|---|---|---|---|---|---|---|---|
| Example 1 | 100 | 94.7 | 89.9 | 78.5 | 69.5 | 64.3 | 58.8 |
| Example 2 | 100 | 93.9 | 83.1 | 77.1 | 67.5 | 61.5 | 57.3 |
| Example 3 | 100 | 91.3 | 84.7 | 73.6 | 67.6 | 62.6 | 55.0 |
| Example 4 | 100 | 91.0 | 82.1 | 70.8 | 64.5 | 60.3 | 54.0 |
| Example 5 | 100 | 90.6 | 80.1 | 68.4 | 62.6 | 58.4 | 52.3 |
| Comparative | 100 | 84.7 | 64.3 | 54.1 | 43.6 | 38.2 | 34.7 |
| Example 1 | | | | | | | |
| Comparative | 100 | 80.9 | 66.3 | 54.1 | 47.9 | 41.3 | 39.9 |
| Example 2 | | | | | | | |

Referring to Table 1, it could be seen that, from 3 hours of heat treatment onward, the absolute quantum efficiency of the cured films prepared in Examples 1 to 5 each containing the compound represented by Formula 1 in the ligand layer was at least about 20% higher than that of the cured films of Comparative Examples 1 and 2, indicating better thermal stability. Accordingly, it is believed that the linear structure at one end of the molecular structure of the first ligand compound strengthens the binding affinity with the quantum dots, while the rigid benzene ring at the other end protects the quantum dots along with two or more ester groups in the molecular structure, thereby further improving thermal stability.

### 2. Evaluation of Photostability

Each of the quantum dot ink compositions 1 to 7 prepared in Examples 1 to 5 and Comparative Examples 1 and 2 was deposited to a thickness of 9.4 m on a glass substrate using a spin coater (Opticoat MS-A150, Mikasa), and cured by exposure at 4,000 mJ (room temperature, 4 sec) using a 395 nm UV exposer. After curing, the cured film was exposed to blue light having a wavelength of 450 nm at a light intensity of 60 mW/cm² for 3 hours using a high light intensity jig instrument (DFH7015B, Think WinTech), and the luminance was measured at intervals of 1 hour during the exposure using a measurement instrument (CA-410, Konica Minolta). Results are shown in Table 2.

TABLE 2

| (Unit: %) | 0 h | 1 h | 2 h | 3 h |
|---|---|---|---|---|
| Example 1 | 100 | 80.9 | 63.6 | 61.0 |
| Example 2 | 100 | 77.1 | 60.4 | 58.3 |
| Example 3 | 100 | 76.7 | 60.8 | 58.8 |
| Example 4 | 100 | 67.5 | 54.9 | 53.3 |
| Example 5 | 100 | 70.2 | 56.3 | 53.9 |
| Comparative Example 1 | 100 | 68.5 | 50.2 | 47.9 |
| Comparative Example 2 | 100 | 69.6 | 52.7 | 49.1 |

Referring to Table 2, it could be seen that, from 2 hours after irradiation, the luminance of the cured films prepared in Examples 1 to 5, each containing the compound represented by Formula 1 in the ligand layer, was about 5% to 10% higher than that of the cured films prepared in Comparative Examples 1 and 2, indicating better photostability. Accordingly, it is also believed that the linear structure at one end of the molecular structure of the first ligand compound strengthens the binding affinity with the quantum dots, while the rigid benzene ring at the other end protects the quantum dots along with two or more ester groups in the molecule, thereby further improving photostability.

The results in Tables 1 and 2 show that thermal and photostability of the quantum dots can be further improved when the compound represented by Formula 1, which contains an aromatic hydrocarbon group at one end of the molecule, a thiol group at the other end thereof, and two or more ester groups in the molecular structure, is used as a ligand.

1. A quantum dot dispersion comprising: quantum dots having a ligand layer on a surface thereof, and a photopolymerizable monomer,
wherein the ligand layer comprises a first ligand compound and a second ligand compound,
the first ligand compound comprising a compound represented by Formula 1,
the second ligand compound comprising a compound having a terminal carboxyl group, 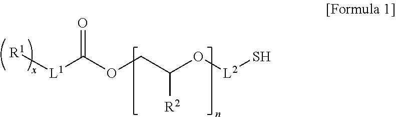
(where R¹ is a C₆ to C₂₀ aromatic hydrocarbon group;
R² is a hydrogen atom or a methyl group;
L¹ is a direct bond or a C₁ to C₁₀ bivalent aliphatic hydrocarbon group, wherein —CH₂— of the bivalent aliphatic hydrocarbon group may be substituted with —O— or —S—;
L² is a C₁ to C₁₀ bivalent aliphatic hydrocarbon group, wherein —CH₂— of the bivalent aliphatic hydrocarbon group may be substituted with —C(═O)— or —OC(═O)—, and —O-L²-comprises at least one ester group;
x is an integer of 1 to 3; and
n is an integer of 1 to 20.)

2. The quantum dot dispersion according to claim 1, wherein the second ligand compound comprises a compound having a terminal carboxyl group and a terminal (meth)acrylate group.

3. The quantum dot dispersion according to claim 1, wherein the quantum dots comprise at least one selected from the group consisting of a Group II-VI compound, a Group III-V compound, a Group IV-VI compound, a Group IV compound, a Group I-III-VI compound, and a Group I-II-IV-VI compound.

4. The quantum dot dispersion according to claim 1, wherein the quantum dots are cadmium-free quantum dots.

5. A quantum dot ink composition comprising: the quantum dot dispersion according to claim 1; a photoinitiator; and scattering particles.

6. The quantum dot ink composition according to claim 5, wherein the photoinitiator comprises at least one selected from the group consisting of a phosphine oxide compound, an acetophenone compound, a benzophenone compound, a triazine compound, a biimidazole compound, an oxime compound, and a thioxanthone compound.

7. The quantum dot ink composition according to claim 5, wherein the scattering particles comprise at least one selected from the group consisting of Al₂O₃, SiO₂, ZnO, ZrO₂, CaCO₃, BaSO₄, BaTiO₃, TiO₂, Ta₂O₅, Ti₃O₅, ITO, IZO, ATO, ZnO—Al, Nb₂O₃, SnO, and MgO.

8. The quantum dot ink composition according to claim 5, comprising, based on the total weight of the quantum dot ink composition,
10 wt % to 60 wt % of the quantum dots having a ligand layer on a surface thereof,
30 wt % to 80 wt % of the photopolymerizable monomer;
0.01 wt % to 10 wt % of the photoinitiator; and
0.5 wt % to 15 wt % of the scattering particles.

9. A cured film comprising a cured product of the quantum dot ink composition according to claim 5.

10. The cured film according to claim 9, wherein, after heat treatment at 180° C. for 5 hours, absolute quantum efficiency of the cured film having a thickness of 9.4 m is at least 40% of that before heat treatment.

11. The cured film according to claim 9, wherein, after irradiation with light having a wavelength of 450 nm at an intensity of 60 mW/cm² for 3 hours, luminance of the cured film having a thickness of 9.4 m is at least 49.5% of that before irradiation.

12. A color filter comprising the cured film according to claim 9.

13. A display device comprising the color filter according to claim 12.
